(19) United States
(12) Patent Application Publication
(10) Pub. No.: US 2003/0057319 A1
(43) Pub. Date: Mar. 27, 2003

(54) Propulsion device with decreased mass

(76) Inventor: David Fitzgerald, Dayton, OH (US)

Correspondence Address: David Fitzgerald, 2432 D Wyoming St., Dayton, OH, 45410, US

(21) Appl. No.: 09/961,545

(22) Filed: Sep. 22, 2001

(51) Int. Cl. B64C 27/00; B64C 39/00; F02G 1/00

(52) U.S. Cl. 244/62

(57) ABSTRACT

A propulsion device which takes advantage of the fact that the mass of an object will decrease if the energy density of the object changes rapidly. The energy density is changed by exposing the object to a rapidly changing electric field or magnetic field or by causing the object to experience quantum mechanical tunneling. By these means, the mass of a rotating object is decreased to one side of the axis of rotation, creating an unbalanced centrifugal force that acts on the rotating object as a propulsive force in the direction from the lower mass half to the higher mass half. The propulsive force is used to propel an object or hold an object in position in opposition to an outside force or provide mechanical energy for a purpose such as the generation of electricity.

### BACKGROUND OF THE INVENTION

1. Field of the Invention

This invention relates generally to an apparatus for providing a propulsive force and more specifically to such an apparatus in which sections of a rotating object are caused to experience a mass decrease through part of the rotational period in order to create an imbalance of forces that results in propulsion.

2. Description of the Prior Art

Commonly used methods of propulsion rely on Newton's third law of motion. This law of motion can be simply stated as: For every action there is an equal and opposite reaction. This can be seen as an aircraft moves forward by pushing air backward, as the tires of an automobile push the Earth in one direction causing the automobile to move in the opposite direction or as an exhaust of burnt propellant fired in a downward direction from a rocket engine sends a spacecraft upward.

The propulsion strategy of this invention is also based on the third law of motion but not through an interaction with nearby matter. Dr. James Woodward, in papers such as Rapid Spacetime Transport and Machian Mass Fluctuations: Theory and Experiment, published by the American Institute of Aeronautics and Astronautics as AIAA-2001-3908 has been able to show that it is possible to reduce the mass of an object by rapidly changing the energy density of that object. This induced mass decrease relies on the identity of inertia, as set forth in Mach's Principle, as being an effect of the gravitational force of all the matter in the universe acting on an object.

Dr. Woodward has experimentally achieved a mass decrease of approximately one percent in a specially designed group of capacitors that are quickly charged and discharged. The present invention makes use of this effect in a rotating object.

### OBJECTS AND ADVANTAGES

The objects and advantages of this invention are:

a. To provide a method of propulsion which does not include the forceful expulsion of an expendable reaction mass;

b. To provide a method of propulsion which does not require an interaction with nearby matter;

c. To provide a method of propulsion which will function in an atmosphere, underwater, or in a vacuum; and

d. To provide a method of propulsion which can be employed to generate electricity.

### SUMMARY OF THE INVENTION

The relevant equation shows that by rapidly changing the energy density of an object, the mass of the object will cycle between its base mass and a lower mass. The average of the object's mass over time would be less than the base mass of the object.

In this invention, mass fluctuation is caused to occur within elements of a rotating object. For the simplest embodiment, each particle of the rotating object will possess its base mass for half of each rotation, then for the other half of each rotation, a decreased time averaged mass is induced in each particle. For example, all particles of the rotating object could retain their base mass during the part of the rotation period when they are to the left of the axis of rotation. As each particle rotates into the area right of the axis, it is given a decreased average mass which is maintained until the particle once more rotates into the area left of the axis of rotation. This results in a propulsive force that would tend to move the rotating object in the direction of the greatest centrifugal force. Centrifugal force acts outward from the axis of the rotating object. Both halves of the rotating object have the same radial acceleration so the centrifugal force on the half of the rotating object having base mass will be greater than the centrifugal force on the half of the object having decreased mass. The propulsive force would be in the direction from the lower mass half to the higher mass half (to the left in the example above).

This invention makes use of three methods of changing the energy density of an object: altering an electric field, altering a magnetic field, and using an electric field to cause quantum mechanical tunneling of charged particles. Other methods of changing the energy density of an object are possible.

This invention could propel any object. It could propel vehicles such as: automobiles, boats, aircraft or spacecraft.

### BRIEF DESCRIPTION OF FIGURES

FIG. 1 shows a propulsion device employing a rotating dielectric disk.

FIG. 2 shows a disk shaped propulsion device with many segments that can be individually charged and discharged.

FIG. 3 shows a propulsion device employing a rotating dielectric cylinder.

FIG. 4 shows a disk shaped propulsion device with many elements that can create magnetic fields.

FIG. 5 shows a disk shaped propulsion device containing many energy storage devices.

FIG. 6 shows a field emission device.

FIG. 7 shows a propulsion device composed of two variables mass devices on a rotating bar.

FIG. 8 is a top view of a device for generating electricity in which two propulsion devices provide rotational motion to turn the shaft of an electric generator.

### REFERENCE NUMERALS IN DRAWINGS

7 dielectric disk

8 drive shaft

9 upper electrode

10 lower electrode

11 electric power source

12 segmented upper electrode

13 segmented lower electrode

14 outer cylindrical electrode

15 inner cylindrical electrode

16 dielectric cylinder

17 electric motor

18 magnetic disk

19 upper disk

20 lower disk

21 magnetic coil

22 rotating disk

23 electromagnetic storage device

24 electron emitter

25 electron collector

32 dc power source

33 beam

28 first variable mass device

29 second variable mass device

30 first propulsion device

31 second propulsion device

32 turntable

33 electric generator shaft

### DETAILED DESCRIPTIONS OF THE FIGURES

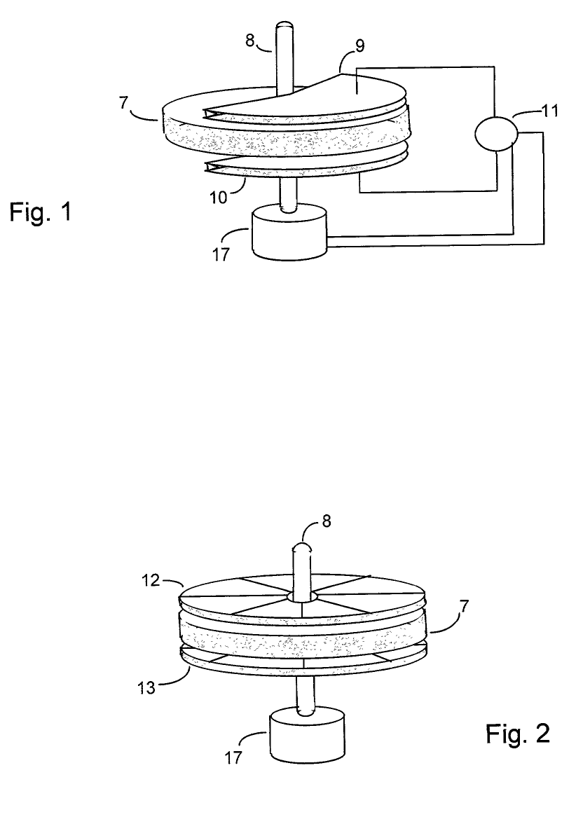

FIG. 1

FIG. 1 shows a propulsion device which takes advantage of the fact that an electric field passing through a dielectric material causes energy to be stored in the dielectric material. The energy density in different parts of the dielectric depends on the magnitude of the electric field passing through each point. The propulsive force will come about because of rapid changes in energy density with a resultant decrease in the mass of a portion of a rotating dielectric object.

In FIG. 1, a drive shaft 8 is attached to a dielectric disk 7 and an electric motor 17. When given power through wires from an electric power source 11, electric motor 17 turns drive shaft 8 causing dielectric disk 7 to rotate between an upper electrode 9 and a lower electrode 10. Only half of dielectric disk 7 is between upper electrode 9 and lower electrode 110. The supporting structure for upper electrode 9 and lower electrode 10 is not shown. Electric power source 11 is connected by wire to upper electrode 9 and lower electrode 10. Electric power source 11 produces an alternating current that causes the electric potentials of upper electrode 9 and lower electrode 10 to vary in opposition to each other. The waveform of the current produced by electric power source 11 could be sinusoidal or saw tooth or any other shape that causes the electric potential difference between upper electrode 9 and lower electrode to rapidly change. The rapidly changing electric potential difference results in a rapidly changing electric field passing through dielectric disk 7, and therefore, the energy density of the half of dielectric disk 7 that is passing between upper electrode 9 and lower electrode 10 at any time rapidly changes.

The rapidly changing energy density of half of dielectric disk 7 causes the time averaged mass of that half of dielectric disk 7 to decrease. Because dielectric disk 7 is rotating, each portion of dielectric disk 7 will possess its base mass for half of the rotational period and a lower mass for the other half of the rotational period. Centrifugal force will be greatest in the direction from the lower mass half of dielectric disk 7 to the higher mass half. Dielectric disk 7 would experience a propulsive force that is in general toward the rear and left of FIG. 1. Physical structures that are not shown connect electric motor 17, upper electrode 9, lower electrode 10 and electric power source 11 so that the entire device shown in FIG. 1 would experience the propulsive force. The entire device would move.

The direction of the propulsive force can be altered by turning upper electrode 9 and lower electrode 10 clockwise or counter clockwise in unison. If upper electrode 9 and lower electrode 10 are both rotated 90 degrees about drive shaft 8, the direction of the force will change by 90 degrees.

FIG. 2

Another method of directing the propulsive force is shown in FIG. 2. A segmented upper electrode 12 and a segmented lower electrode 13 are each divided into eight wedges. Supporting structure is not shown. Dielectric disk 7 is between segmented upper electrode 12 and segmented lower electrode 13. Drive shaft 8 is connected to dielectric disk 7 but passes through openings in segmented upper electrode 12 and segmented lower electrode 13. Electric motor 17 (power source not shown) causes dielectric disk 7 to rotate on drive shaft 8. Each wedge in segmented upper electrode 12 and in segmented lower electrode 13 is connected by wire to an electric power source that is not shown. To cause a propulsive force, four contiguous wedges in segmented upper electrode 12 are given an electric potential that alternates with the electric potential given to the four contiguous wedges that are directly below them in segmented lower electrode 13. As in FIG. 1, half of rotating dielectric disk 7 is exposed to a rapidly changing electric field, causing a time averaged decrease in mass to the half of dielectric disk 7 that is within the electric field at each point in time. The direction of propulsion is from the lower mass half to the half having base mass. The direction of propulsion is altered by giving the varying electric potentials to a different group of four contiguous wedges in segmented upper electrode 12 and the four wedges in segmented lower electrode 13 beneath them.

FIG. 2—Alternative Embodiments

Segmented upper electrode 12 and segmented lower electrode 13 are each composed of eight wedges in FIG. 2. This number of wedges limits the amount of direction change for the propulsive force to no less than 45 degrees. A greater number of smaller wedges could be used to give finer control over the direction of the propulsive force. Wedges are a convenient shape for the segments in FIG. 2. Other shapes for the segments could be used.

In FIG. 2, as dielectric disk 7 moves within the electric field produced by segmented upper electrode 12 and segmented lower electrode 13 it will be affected by a magnetic field. Polarization charges on dielectric disk 7 will interact with the magnetic field to act as a brake and slow the rotation of dielectric disk 7. The braking action can be substantial but can be combated. It isn't necessary that dielectric disk 7 rotate with respect to segmented upper electrode 12 and segmented lower electrode 13. Segmented upper electrode 12 and segmented lower electrode 13 could be attached to drive shaft 8 so that segmented upper electrode 12 and segmented lower electrode 13 would rotate along with dielectric disk 7. Electric power connections from an electric power source would be routed through drive shaft 8. Alternating electric power would be given to segments of segmented upper electrode 12 and segmented lower electrode 13 at times in the rotational period when it would cause a propulsive force in the desired direction.

It is also possible to produce a propulsive force using a constant, rather than rapidly changing electric field using the device shown in FIG. 2. One wedge in segmented upper electrode 12 and the wedge below it in segmented lower electrode 13 are given different electric potentials, creating a constant electric field between them. As dielectric disk 7 turns, each point in dielectric disk 7 passes through the constant electric field, experiencing an increase and then a decrease in energy density as it leaves the electric field. As a consequence, the portions of dielectric disk 7 that are closest to the edges of the upper and lower wedges that are responsible for the electric field will have decreased time averaged mass. The mass decrease will become greater as the rotational velocity of dielectric disk 7 is increased. Centrifugal force will be least for the portion of dielectric 7 that passes through the electric field so the direction of the propulsive force will be from this portion toward the opposite side of dielectric disk 7.

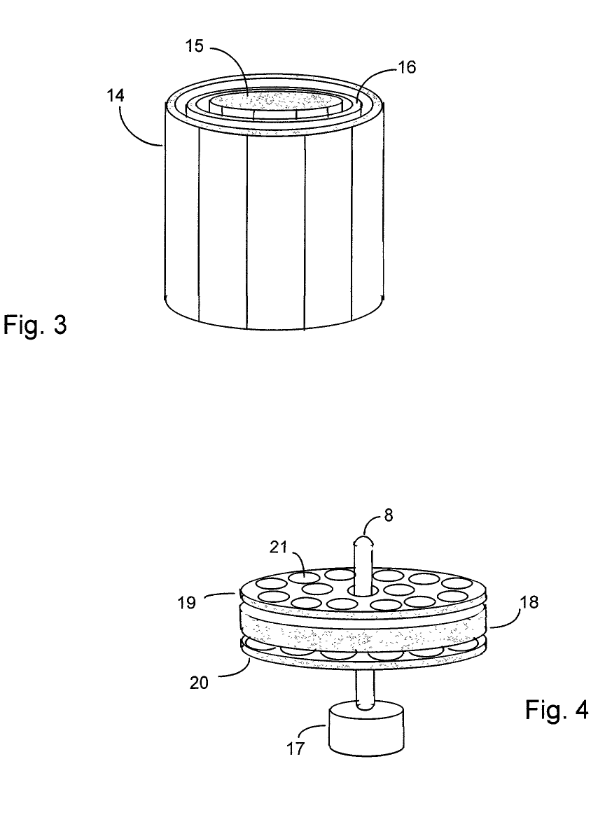

FIG. 3

In FIG. 3, a dielectric cylinder 16 rotates between an outer cylindrical electrode 14 and an inner cylindrical electrode 15. Outer cylindrical electrode 14 and inner cylindrical electrode 15 are each made of many segments. Dielectric cylinder 16 is caused to rotate by an electric motor that is not shown. In order to cause a propulsive force, those sections of outer cylindrical electrode 14 and inner cylindrical electrode 15 that are on the opposite half of dielectric cylinder 16 from the intended direction of the propulsive force are given alternating electric potentials so that the half of dielectric cylinder 16 rotating between those segments of outer cylindrical electrode 14 and inner cylindrical electrode 15 experiences a rapidly changing electric field and therefore a rapidly changing energy density. The changing energy density causes that half of dielectric cylinder 16 passing through the electric field to have a reduced average mass. As in FIGS. 1 and 2, centrifugal force will cause a propulsive force directed from the lower mass half of dielectric cylinder 16 to the higher mass half.

Steering of the force is accomplished by the choice of which segments of outer cylindrical electrode 14 and inner cylindrical electrode 15 are given the alternating electric potentials.

FIG. 4

In FIGS. 1, 2 and 3, a rapidly changing electric field passes through a dielectric material. A disk or cylinder made of a material that changes energy density when exposed to a magnetic field could also be used. such a magnetic material could be ferromagnetic, such as iron, or paramagnetic or diamagnetic. In FIG. 4, a magnetic disk 18, which is made of a ferromagnetic material, is attached to drive shaft 8, which is connected to electric motor 17. An electric current delivered to electric motor 17 through wires that are not shown causes electric motor 17 to turn drive shaft 8 so that magnetic disk 18 is caused to rotate. Magnetic disk 18 rotates between an upper disk 19 and a lower disk 20. Upper disk 19 and lower disk 20 are not attached to drive shaft 8. Upper disk 19 and lower disk 20 contain many examples of a magnetic coil 21. An electric power source that is not shown provides electric power to magnetic coils 21 in one half of upper disk 19 and the corresponding half of lower disk 20 so that the set of magnetic coils 21 above and below half of magnetic disk 18 creates a rapidly changing magnetic field that interacts with magnetic disk 18. The rapidly changing magnetic field causes a rapid change in energy density and therefore a time averaged decrease in mass for the half of magnetic disk 18 that is passing through the magnetic field at any time. The direction of the propulsive force would be from the lower mass half of magnetic disk 18 to the higher mass half.

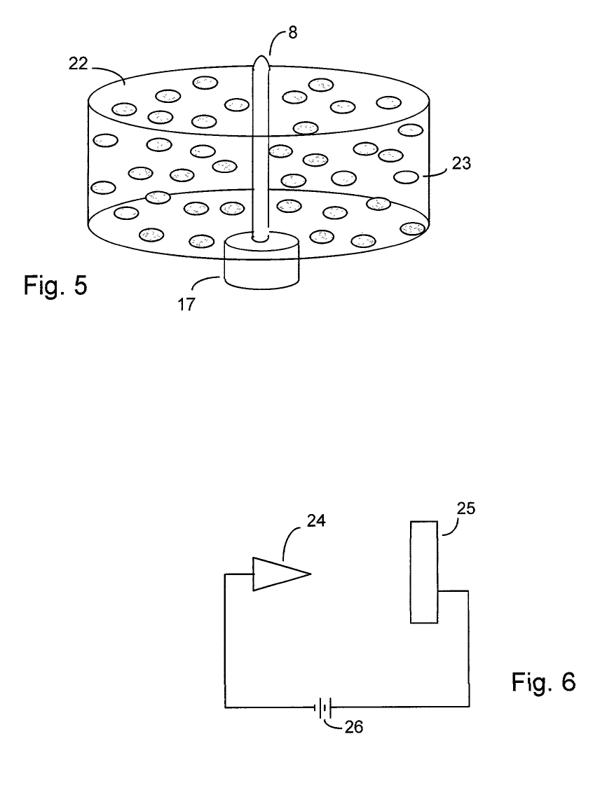

FIG. 5

In FIG. 5, a rotating disk 22 and drive shaft 8 are caused to rotate by electric motor 17. Rotating disk 22 is shown as being transparent so that it can be seen to contain many examples of an electromagnetic storage device 23. Rotating disk 22 is made of a material that can support electromagnetic storage devices 23 and can withstand high rotation speeds. Electromagnetic storage device 23 could be any device, such as a capacitor or an inductor, which stores energy when exposed to an electric current. Through connections that are not shown, each electromagnetic storage device 23 is connected to an electric power source. The electric power source can quickly give energy to selected electromagnetic storage devices 23 then quickly take the energy away. This causes each electromagnetic storage device 23 to have a time averaged mass that is lower than the base mass for the time during which its energy density is rapidly changed. Propulsion would be achieved if electromagnetic storage devices 23 were operating at lower mass in the half of rotating disk 22 that was in the opposite direction of the intended propulsive force. For example, rotating disk 22 would experience a propulsive force to the right in FIG. 5 if electromagnetic storage devices 23 in the left half of rotating disk 22 were in operation. As electromagnetic storage devices 23 rotate out of the left half of rotating disk 22, the electric current allowing then to operate would be stopped. At the same time, electromagnetic storage devices 23 that rotate into the left half of rotating disk 22 would be given an electric current that would cause their mass to decrease. Centrifugal force causes a propulsive force that acts on rotating disk 22 and electromagnetic storage devices 23. Since electromagnetic storage devices 23 are part of rotating disk 22, the propulsive force at any point in time is in the direction from the half of rotating disk 22 containing the lower mass electromagnetic storage devices 23 toward the half of rotating disk 22 containing the higher mass electromagnetic storage devices 23.

Each electromagnetic storage device 23 could also be composed of an inductor and a capacitor that are electrically connected to each other. Each inductor and the capacitor that it is paired with constitute a resonant circuit with the power source. As a resonant circuit, an oscillating electric current can be established between the capacitor and the inductor of each capacitor inductor pair. A current from the power source causes the capacitor and the inductor to quickly alternate in storing and releasing energy. This causes the time averaged mass of a capacitor inductor pair to decrease. The propulsive force would once again be from the low mass half to the high mass half of rotating disk 22.

FIG. 6

It is known that during electron tunneling, the emitted electrons possess negative kinetic energy. Electrons are emitted by tunneling through an energy barrier. During the tunneling process, potential energy is added to the electrons, increasing their energy density. Potential energy is considered to be negative energy. The presence of negative kinetic energy reflects the fact that, while tunneling, potential energy increases at such a rate that the mass of the electrons becomes negative. Two means by which tunneling allows electrons to leave the surface of a material are resonant tunneling and field emission.

Field emitters can be very small. In U.S. Pat. No. 3,755,704 by Spindt et al the field emitters are cone shaped, having a height and a base diameter of approximately 1 micron. FIG. 6 shows a device for producing field emission of electrons. A dc power source 26 is connected to an electron emitter 24 and an electron collector 25 by wire. Power source 26 causes electron collector 25 to have a greater electric potential than electron emitter 24, causing field emission of electrons from electron emitter 24. The emitted electrons travel to electron collector 25. While the field emission occurs, the mass of the apparatus shown in FIG. 6 is less than its base mass.

A propulsive force would be produced if the electromagnetic storage devices 23 of FIG. 5 were composed of many examples of the field emission device of FIG. 6. The direction of propulsion would be as described in FIG. 5.

A greater mass change could be obtained if the particles released by field emission were more massive than electrons, such as ions. In a paper entitled Miniaturized Liquid Metal Ion Sources (MILMIS) published in October 1991 IEEE transactions on electron devices, J. Mitterauer discusses field emission of positively charged ions of mercury and other elements.

A propulsive force would be produced if the electromagnetic storage devices 23 of FIG. 5 were composed of many examples of ion field emission devices The direction of propulsion would be as described in FIG. 5.

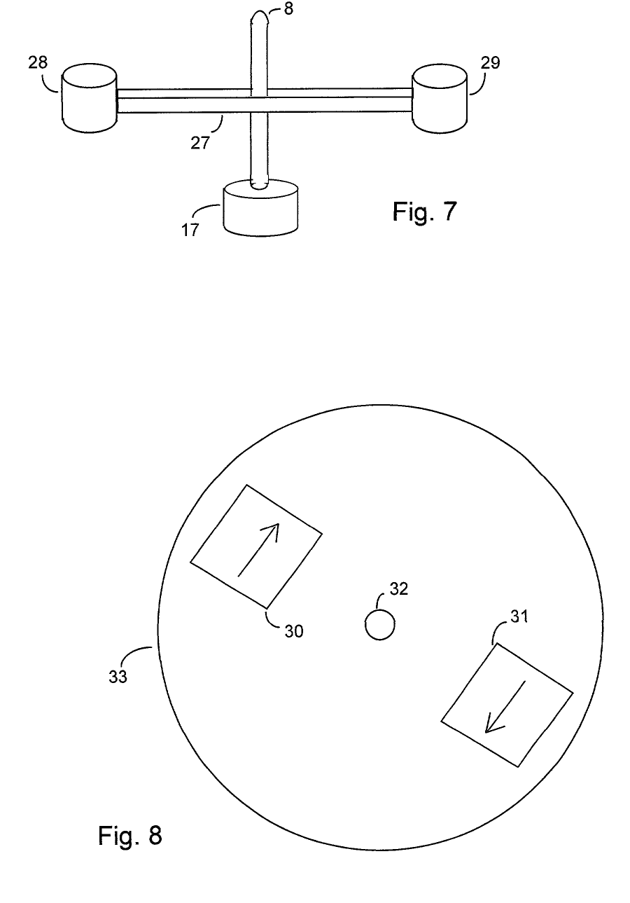

FIG. 7

In FIG. 7, a beam 27 is attached to drive shaft 8. A first variable mass device 28 is attached to one end of beam 27 while a second variable mass device 29 is attached to the other end of beam 27. Electric motor 17 causes drive shaft 8 to turn so that beam 27, first variable mass device 28 and second variable mass device 29 rotate. Both first variable mass device 28 and second variable mass device 29 can be any device, such as those described above, which is caused to develop a time averaged mass that is lower than its base mass. The propulsive force comes about because each variable mass device is given the electric current that causes the lower time averaged mass for half of its rotational period, when it is opposite to the intended direction of propulsion. The current is discontinued (mass equals base mass) during the half of the rotational period that a variable mass device is in the intended direction of propulsion.

FIG. 8

FIG. 8 shows a method of generating electricity that employs the propulsive force produced by this invention. In FIG. 8, a first propulsion device 30 and a second propulsion device 31 are fixed to a turntable 32 that is attached to an electric generator shaft 33. Electric generator shaft 33 is connected to an electric generator that is not shown. The internal structures of first propulsion device 30 and second propulsion device 31 are not shown. First propulsion device 30 and second propulsion device 31 could be propulsion devices as shown in FIGS. 1, 2, 3, 4, 5, or 7.

The arrows shown on first propulsion device 30 and second propulsion device 31 indicate the directions that first propulsion device 30 and second propulsion device 31 would be propelled if they were not attached to turntable 32. The propulsive force due to first propulsion device 30 and second propulsion device 31 causes turntable 32 and electric generator shaft 33 to rotate in a clockwise direction. The rotation of electric generator shaft 33 causes the generation of electricity by the electric generator that electric generator shaft 33 is connected to.

The rotation of turntable 32 could be used for purposes other than the generation of electricity. Electric generator shaft 33 could be replaced by a drive shaft connected to any type of machinery that requires rotation to operate. Alternatively, teeth cut into the outer edge of turntable 32 would make turntable 32 a driving gear that could drive any type of machinery that requires rotation to operate.

FIGS. 8, 1, 2, 3, 4, 5 and 7—Enhancement

The rotational motion found in FIG. 8 would cause gyroscopic forces. This isn't a problem for a stationary electric power source but it would be a problem if the power source of FIG. 8 were in a moving vehicle. Any turning motion of the vehicle that was not in the plane of turntable 32 would cause unwelcome forces on the vehicle. Turntable 32 could be mounted on gimbals so that, as a vehicle changes direction, turntable 32 would be free to turn on any axis.

All of the propulsion devices shown in FIGS. 1, 2, 3, 4, 5 and 7 engage in rapid rotation. If any of these devices provided the propulsive force for a vehicle, there would be gyroscopic forces that could have an adverse effect on the ability to control the vehicle's direction of travel. Mounting these propulsion devices on gimbals would limit the unwanted effects.

Conclusion, Ramifications, and Scope of Invention

While the above descriptions contain many specificities, these should not be construed as limitations on the invention, but rather as examples of embodiments of this invention Other variations are possible. For example, the propulsive force provided by this invention need not cause motion of an object it is attached to but might work against another force, such as the force of gravity, to slow the motion of an object or to hold an object in place. Also, the equation governing the decrease in mass due to rapid changes in energy density includes a term which leads to an increase or decrease in mass that comes about because of non-linear changes in energy density. To lessen this contribution to the mass of a propulsion device, changes in energy density should be made as nearly linear as possible.

The above descriptions dealt with rotating disks and a rotating cylinder. Objects of other shapes can be used, such as a rod rotating on its short axis with devices at one or both ends that have decreasable mass. While the descriptions of the figures included rotational motion of a physical object, any motion that is non-linear will create the centrifugal force that is necessary for propulsion in this invention. Accordingly; the scope of the invention should not be determined by the embodiments illustrated, but by the appended claims and their legal equivalents.

I claim:

1. A device for producing a propulsive force, comprising;
a. a moving physical material,
b. an energy density altering means, which alters the energy density within said moving physical material in such a way that the mass density of said moving physical material is altered, creating a propulsive force that acts on said moving physical material.

2. A device as in claim 1 in which said moving physical material is substantially composed of a moving dielectric material.

3. A device as in claim 1 in which said moving physical material is substantially composed of a moving magnetic material.

4. A device as in claim 1 in which said moving physical material is substantially in rotational motion.

5. A device as in claim 1 in which said energy density altering means is an electric field creating means, which creates an electric field that decreases the mass of said moving physical material so as to cause a propulsive force that acts on said moving physical material.

6. A device as in claim 1 in which said energy density altering means is a magnetic field creating means, which creates a magnetic field that decreases the mass of said moving physical material so as to cause a propulsive force that acts on said moving physical material.

7. A device as in claim 1 in which said energy density altering means is a field emission device.

8. A device as in claim 1 including an electric generating means which converts kinetic energy derived from said propulsive force into electrical energy.

9. A device as in claim 8 in which the electrical energy produced is the energy source for the operation of said energy density altering means.

10. A device as in claim 8 in which the electrical energy produced is the energy source for causing the motion of said moving physical material.

11. A device as in claim 1 in which said propulsive force is employed to propel an object, which could be a vehicle.

12. A device as in claim 1 in which said propulsive force is employed to cause rotational motion.

13. A device as in claim 1 in which said propulsive force is employed in opposition to another force to alter the velocity of an object's motion.

14. A device as in claim 1 in which said propulsive force is employed in opposition to another force to prevent an object's motion.

15. A device as in claim 1 in which said moving physical material is substantially disk shaped.

16. A device as in claim 1 in which said moving physical material is substantially cylindrical.

17. A device as in claim 1 in which said moving physical material is charged particles.

18. A device as in claim 4 in which said moving physical material is mounted so as to allow rotation in a direction other than in the plane rotation of said moving physical material.
